(19) United States
(12) Patent Application Publication
(10) Pub. No.: US 2003/0096595 A1
(43) Pub. Date: May 22, 2003

(54) Authentication of a mobile telephone

(76) Inventors: Michael Green, Zichron Yaakov (IL); Yoram Rimoni, Haifa (IL)

Correspondence Address: QUALCOMM Incorporated, Attn: Patent Department, 5775 Morehouse Drive, San Diego, CA, 92121-1714, US

(21) Appl. No.: 10/289,507

(22) Filed: Nov. 5, 2002

Related U.S. Application Data
(60) Provisional application No. 60/332,117, filed on Nov. 21, 2001.

(51) Int. Cl. H04Q 7/20

(52) U.S. Cl. 455/411; 455/466; 380/247

(57) ABSTRACT

A method for enabling a mobile telephone to operate in a communications network, including: generating a random authentication number and an expected response to the random authentication number, and transmitting a forward short message service (SMS) message incorporating the random authentication number to the mobile telephone. The method further includes generating at the mobile telephone, responsive to the random authentication number, an authentication response, and receiving from the mobile telephone a return SMS message incorporating the authentication response. The method also includes performing a comparison between the authentication response in the return SMS message and the expected response, and authenticating the mobile telephone to operate in the communications network responsive to the comparison.

### CROSS-REFERENCE TO RELATED APPLICATIONS

This application claims the benefit of U.S. Provisional Patent Application No. 60/332,117, filed Nov. 21, 2002, which is incorporated herein by reference.

I. Field Of The Invention

The present invention relates generally to methods of verification, and specifically to a method for authenticating a mobile telephone operating in a cellular communication network.

II. Background Of The Invention

Mobile telephones operating within a cellular communication network undergo a process of authentication before being able to place or receive calls. The authentication, inter alia, prevents fraudulent use of the mobile. Two types of networks wherein authentication is performed are a Code Division Multiple Access (CDMA) network, and a Global System for Mobile Communications (GSM) network, which operates in a Time Division Multiple Access (TDMA) format.

FIG. 1 is a schematic diagram illustrating a process of authentication in a cellular network 10, as is known in the art. A mobile telephone 12 in network 10 transmits an initial signal to a mobile switching center (MSC) 16 communicating with a base-station system (BSS) 14. In order to be authenticated for operation in the network, MSC 16 instructs an authentication center (AUC) 18 to generate a random authentication number 20, typically as a triplet. Authentication number 20 is transmitted to mobile telephone 12 within an authentication packet 22. The generation is performed using data derived from a home location register (HLR) 29. MSC 16, AUC 18, and HLR 29 are comprised in a backbone of network 10, to which BSS 14 is coupled. The mobile telephone processes the number through an authentication algorithm comprised in the mobile in order to generate a reply value 24. The reply value is transmitted in an authentication response packet 26 to the MSC. The MSC checks, with AUC 18 and HLR 29, if random number 20 and reply 24 satisfy authentication criteria of the network. If the criteria are satisfied, the mobile telephone is allowed to continue operating within the network.

Network 10 also comprises a short message service center (SMS-C) 28 in the backbone of the network, which is able to transmit and receive short alphanumeric messages. Mobile telephone 12 may be implemented to receive and transmit such SMS messages. Typically, alphanumeric messages transmitted and received by an SMS-C consist of approximately 128 characters, although higher numbers of characters may be transferred.

If network 10 comprises a CDMA network operating according to an industry-standard protocol, such as a TIA/EIA/IS-2000-A-1 standard published by the Telecommunications Industry Association, Arlington, Va., mobile 12 comprises a CDMA mobile. AUC 18 implements an ANSI-41 protocol, published by the 3rd Generation Partnership Project 2, which may be found at http://www.3gpp2.org, and which is incorporated herein by reference. In this case, random authentication number 20 sent from the authorization center is a 32-bit number, and reply value 24 generated by the CDMA mobile is an 18-bit number. In order to perform the authentication, the CDMA mobile thus needs to be able to transmit its authentication reply as an 18-bit number.

If network 10 comprises a GSM network operating according to an industry-standard protocol, such as an ETSI TS 100 940 V7.8.0 technical specification, published by the European Telecommunications Standards Institute, Sophia Antipolis Cedex, France, mobile 12 comprises a GSM mobile. Section 4.3 of the specification, incorporated herein by reference, describes the authentication procedure followed in a GSM network. In this case, the random authentication number sent from the authorization center is a 128-bit number, and the reply value generated by the GSM mobile is a 32-bit number. In order to perform the authentication in the GSM network, the GSM mobile needs to be able to transmit its authentication reply as a 32-bit number.

If a CDMA mobile is to operate in a GSM network, however, the authentication reply which the mobile needs to generate, a 32-bit number, is larger than the 18-bit capability of the CDMA mobile. Methods known in the art for overcoming the limited capability of the CDMA mobile include changing software in both the GSM authentication center and the CDMA mobile. When the CDMA mobile is to operate in its native CDMA environment, the software is replaced by the original software. An alternative procedure which is known in the art is to change software in the GSM center so that only “CDMA-type” authentication is performed on CDMA mobiles operative in the GSM network. It will be appreciated that both methods are problematic.

### SUMMARY OF THE INVENTION

It is an object of some aspects of the present invention to provide a method and apparatus for authenticating a mobile telephone to operate in a communications network.

In a preferred embodiment of the present invention, a mobile telephone is to be operated within a cellular communications network. A base station or a switching center in the network authenticates the mobile telephone by transmitting an authentication request in the form of a message, most preferably a short messaging system (SMS) message, to the mobile. The SMS message comprises a first identifier defining the SMS message as the authentication request, together with a random number which is used as part of an authentication procedure. By analyzing the first identifier, the mobile telephone recognizes the SMS message as the authentication request and processes the accompanying random number through an authentication algorithm comprised in the mobile telephone, so as to generate an authentication response. The response is sent in a return SMS message transmitted from the mobile to the network. The return SMS message comprises a second identifier defining the return message as including the authentication response. The network recovers the response from the return message, and compares the recovered response with an expected response, in order to authenticate the mobile telephone. Using SMS messages as delivery systems for authentication requests and responses avoids limitations on sizes of the random number and of responses in systems known in the art.

In some preferred embodiments of the present invention, the mobile telephone is able to operate in more than one communications network. Each network comprises a different authentication protocol, each protocol defining a different size for the random number and response. The mobile can be authenticated in its “native” network, or in a network operating under a different protocol, without software or hardware changes in the mobile as it moves from network to network.

In an alternative preferred embodiment of the present invention, where the network within which the mobile operates supports data burst messages (DBMs), the authentication request message to the mobile, and the authentication response message from the mobile, are sent as DBMs. Most preferably, the DBMs are of a type already supported by a communications protocol under which the network is operating.

The present invention will be more fully understood from the following detailed description of the preferred embodiments thereof, taken together with the drawings, in which:

### BRIEF DESCRIPTION OF THE DRAWINGS

FIG. 1 is a schematic diagram illustrating a process of authentication in a cellular communications network, as is known in the art;

FIG. 2 is a schematic diagram illustrating a process of authentication of a mobile telephone, according to a preferred embodiment of the present invention; and

FIG. 3 is a sequence diagram showing steps involved in authentication of the mobile telephone of FIG. 2 operating in a communications network, according to a preferred embodiment of the present invention.

### DETAILED DESCRIPTION OF PREFERRED EMBODIMENTS

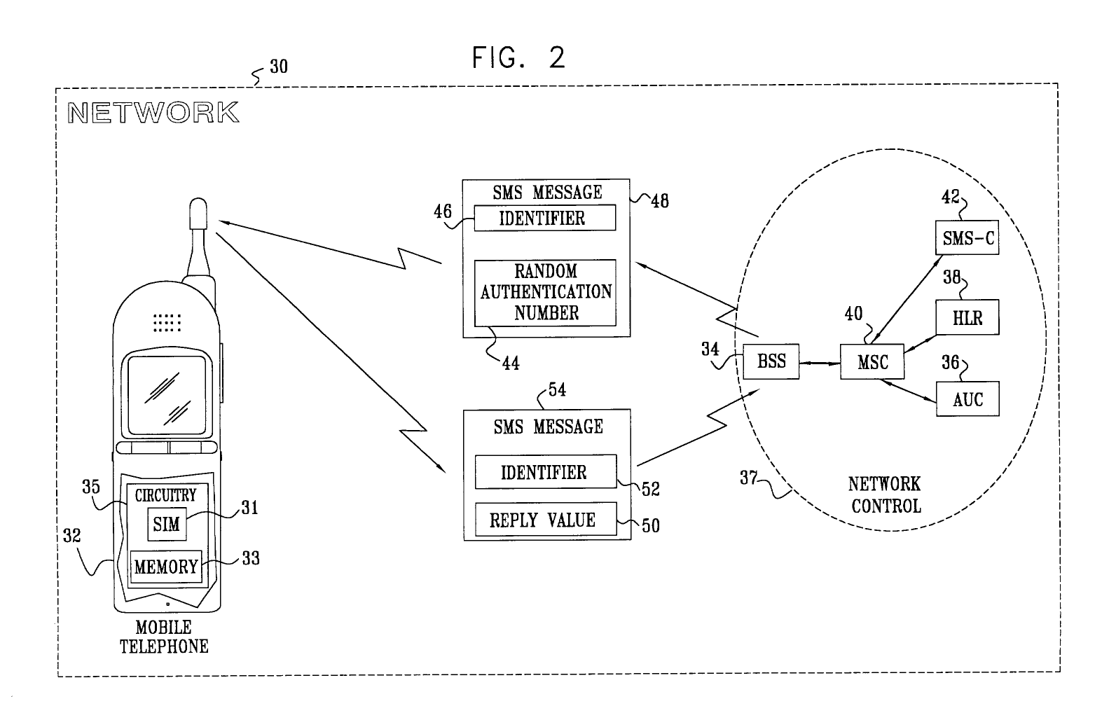

Reference is now made to FIG. 2, which is a schematic diagram illustrating a process of authentication of a mobile telephone 32, according to a preferred embodiment of the present invention. Mobile telephone 32 is adapted to operate in a cellular communications network 30, which functions according to a first industry-standard cellular communications protocol. The mobile comprises circuitry 35 enabling the mobile to operate. Most preferably, mobile 32 is adapted to operate according to the first protocol, as well as being operative according to a second industry-standard cellular communications protocol. For example, the first protocol comprises a Global System for Mobile Communications (GSM) protocol, such as an ETSI TS 100 940 V7.8.0 technical specification referred to in the Background of the Invention, and the second protocol comprises a Code Division Multiple Access (CDMA) protocol, such as a TIA/EIA/IS-2000-A-1 standard also referred to in the Background of the Invention. Alternatively, mobile 32 is operative according to either a GSM or a CDMA industry-standard protocol, or according to another protocol known in the art.

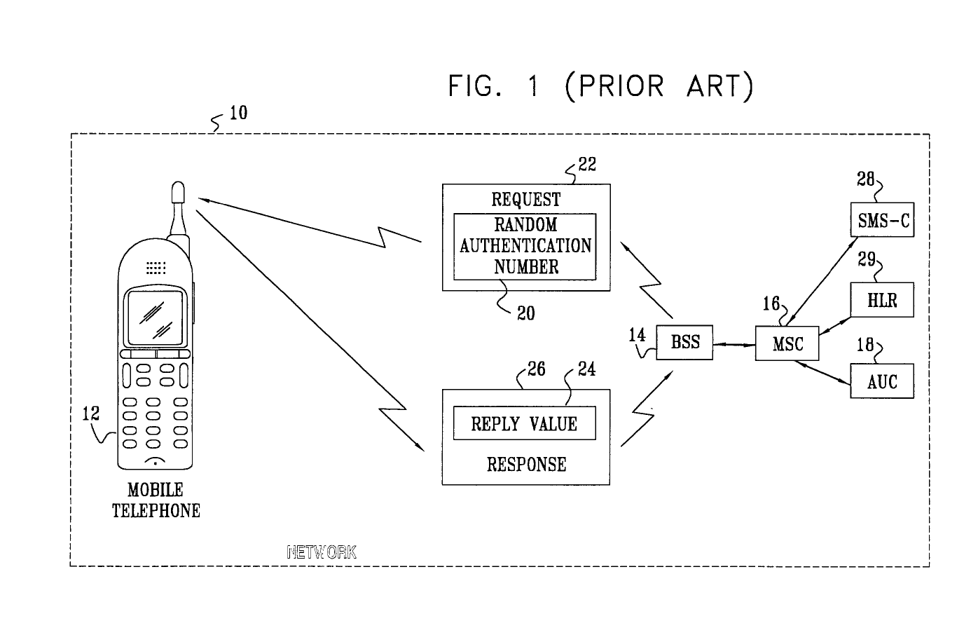

A base-station system (BSS) 34 is coupled to a mobile switching center (MSC) 40, which is in turn coupled to an authentication center (AUC) 36, and a home location register (HLR) 38. Optionally, a short message service center (SMS-C) 42 may also be coupled to MSC 40. One or more of BSS 34, AUC 36, HLR 38, and MSC 40 act as a network control center 37, controlling transmissions within network 30. Except for the differences described below, AUC 36, HLR 38, MSC 40, and SMS-C 42 respectively operate generally as AUC 18, HLR 29, MSC 16, and SMS-C 28, described with reference to FIG. 1 in the Background of the Invention.

Mobile 32 wishes to operate in network 30, and transmits an initial signal to BSS 34. In order to authenticate the mobile, BSS 34 transmits a random authentication number 44, encapsulated in a first, forward, message 48, to mobile 32. Except where otherwise stated hereinbelow, message 48 is assumed to comprise an SMS message. Message 48 incorporates an identifier 46 within the message, so that mobile 48 is able to recognize SMS message 48 as a special message conveying the random authentication number. On receipt of SMS message 48, mobile 32 decodes the message, recovers the value of random authentication number 44, and applies the recovered value to an authentication algorithm comprised in the mobile, to generate an authentication response. Preferably, software for decoding message 48, recovering number 44, and the authentication algorithm is incorporated as a separate replaceable element 31, most preferably as a subscriber identity module (SIM) within mobile 32. Alternatively, the software is incorporated integrally within a memory 33 of the mobile.

Mobile 32 incorporates the authentication response in a second, return, message 54, as a reply value 50, and transmits the message to BSS 34. Except where otherwise stated hereinbelow, message 54 is assumed to comprise an SMS message. Mobile 32 incorporates an identifier 52 in message 54, so that the message may be recognized as a special message conveying the authentication reply. SMS message 54 is routed by BSS 34 to MSC 40, which, from identifier 52, recognizes the message as comprising the authentication reply, and extracts reply value 50 from the message. MSC 40 checks that value 50 corresponds with an expected response to random number authentication 44, and if there is a correspondence, authenticates mobile 32. By incorporating random number authentication 44 and reply value 50 in SMS messages, limitations on sizes of the random number authentication and the reply value, as defined by the different protocols under which mobile 32 operates, are overcome. The limitations are overcome since SMS messages are able to transmit 128 or more 8-bit characters.

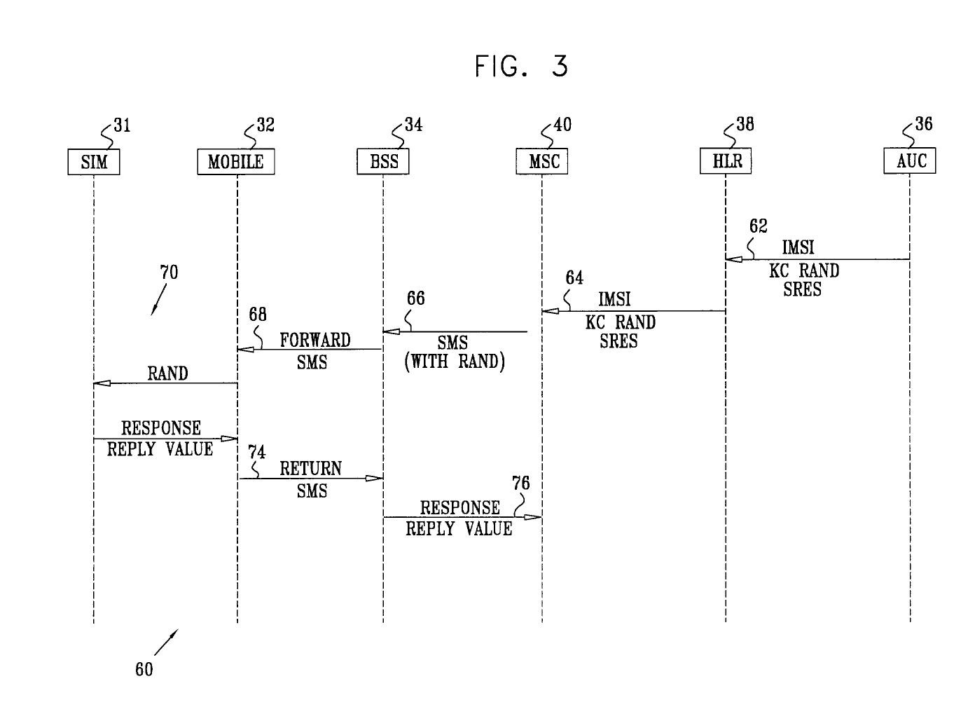

FIG. 3 is a sequence diagram 60 showing steps involved in authentication of mobile telephone 32 operating in network 30, according to a preferred embodiment of the present invention. By way of example, network 30 is assumed to operate according to a GSM protocol. Sequence diagram 60 illustrates steps performed before and after mobile 32 has made an initial transmission, received by BSS 34, and is awaiting authentication. The initial transmission incorporates an international mobile subscriber identity (IMSI), typically the telephone number of mobile 32, which has been allocated to the mobile when it is initially registered in the network, and which is also stored in AUC 36. Also at registration, mobile 32 is allocated a subscriber authentication key (Ki), which is stored both in the mobile and in AUC 36.

In a first step 62, AUC 36 generates a random number (RAND), and uses RAND to calculate an identification parameter, termed signal response (SRES), which is a function of RAND and Ki. AUC 36 also calculates an encryption key (Kc) which is a function of Ki and RAND. IMSI, Kc, RAND, and SRES are transferred and stored in HLR 38.

In a second step 64, HLR 38 transfers the values of IMSI, Kc, RAND, and SRES to MSC 40, after the MSC has received the initial transmission via BSS 34. MSC 40 stores IMSI, Kc, RAND, and SRES for later comparison purposes.

In a third step 66, MSC 40 incorporates the RAND value, corresponding to random authentication number 44 (FIG. 2) into SMS message 48. The SMS message is transferred to BSS 34 via either a traffic or a control channel. Alternatively, if network 30 comprises a CDMA 2000 network, the transfer may be made using an Application Data Delivery Service (ADDS).

In a fourth step 68, BSS 34 adds identifier 46 to the message and transmits the message to mobile 32.

In a fifth step 70, mobile 32 identifies SMS message 48, by identifier 46, as a message comprising number 44, using software comprised in SIM 31 or memory 33 of the mobile. The mobile uses number 44, and the mobile's stored values of IMSI and Ki, to generate reply value 50 as a signal response to number 44. The mobile then constructs SMS message 54, incorporating reply value 50 and identifier 52.

In a sixth step 74 the mobile transmits SMS message 54 to BSS 34.

In a final step 76, BSS 34 transfers SMS message 54 to MSC 40, which identifies the SMS message, from identifier 52, as a response to the authentication SMS message 48. MSC 40 then recovers the value of reply value 50, as a signal response, from message 54, and compares the recovered value with an expected value of SRES received from HLR 38 in second step 64. If the two signal responses tally, MSC 40 authenticates the mobile; if the responses do not tally, the mobile is not authenticated.

It will be appreciated that the descriptions above with respect to FIGS. 2 and 3 apply to substantially any mobile transceiver operating in a cellular communication network, wherein the transceiver is capable of transmitting and receiving SMS messages. Thus, the scope of the present invention is not limited to any specific protocol or method of transmission utilized by the transceiver and/or the network.

In an alternative preferred embodiment of the present invention, wherein BSS 34 and mobile 32 are able to communicate via a spread spectrum system such as a code division multiple access (CDMA) system, messages 48 and 54 (FIG. 2) comprise short data burst messages. Data burst messages are described and characterized in TIA/EIA/IS-2000-A-1 standard, referred to in the Background of the Invention. The data burst messages are preferably implemented according to one of the predefined types incorporated in the standard, or alternatively via a custom-defined type. If messages 48 and 54 are in the form of data burst messages, then in sixth step 74 and final step 76 BSS 34 identifies the data burst message as an authentication response, recovers reply value 50, and provides the value to MSC 40. The MSC then performs the comparison between the recovered value and the expected value of SRES.

By incorporating random authentication numbers and responses to these numbers in SMS or data burst messages, limitations on sizes of the numbers and of the responses are avoided. Such size limitations, i.e., respective numbers of bits for the random authentication number and its response, are typically defined by a specific protocol. Using SMS or data burst messages as delivery systems thus enables a mobile telephone to be authenticated in a variety of protocols, without changing software or hardware in the mobile telephone.

It will be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for enabling a mobile telephone to operate in a communications network, comprising:
generating a random authentication number and an expected response to the random authentication number;
transmitting a forward short message service (SMS) message incorporating the random authentication number to the mobile telephone;
generating at the mobile telephone, responsive to the random authentication number, an authentication response;
receiving from the mobile telephone a return SMS message incorporating the authentication response;
performing a comparison between the authentication response in the return SMS message and the expected response; and
authenticating the mobile telephone to operate in the communications network responsive to the comparison.

2. A method according to claim 1, wherein the mobile telephone is adapted to be operative in a plurality of different communication protocols.

3. A method according to claim 2, wherein the random authentication number comprises a random-authentication-number-size, and the expected response and the authentication response each comprise an expected-response-size, and wherein the random-authentication-number-size and the expected-response-size have values responsive to respective protocols comprised in the plurality of protocols.

4. A method according to claim 1, and comprising:
incorporating into the forward SMS message a forward identifier adapted to enable the mobile telephone to recognize the forward SMS message as an authentication request; and
the mobile telephone incorporating into the return SMS message a reverse identifier, so that the return SMS message is recognized as an authentication answer.

5. Apparatus for enabling a mobile telephone to operate in a communications network, comprising:
a network control center which is adapted to:
generate a random authentication number and an expected response to the random authentication number,
incorporate the random authentication number in a forward short message service (SMS) message, and
transmit the forward SMS message to the mobile telephone; and
circuitry, comprised in the mobile telephone, which is adapted to:
generate, responsive to the random authentication number, an authentication response,
incorporate the authentication response in a return SMS message, and
transmit the return SMS message to the network control center,
the network control center being further adapted to make a comparison between the authentication response and the expected response, and to authenticate the mobile telephone for operation in the communications network responsive to the comparison.

6. Apparatus according to claim 5, wherein the network control center comprises at least one of a base-station system (BSS), a mobile switching center (MSC), and an authentication center (AUC).

7. Apparatus according to claim 5, wherein the circuitry is adapted to operate the mobile telephone in a plurality of different communication protocols.

8. Apparatus according to claim 7, wherein the random authentication number comprises a random-authentication-number-size, and the expected response and the authentication response each comprise an expected-response-size, and wherein the random-authentication-number-size and the expected-response-size have values responsive to respective protocols comprised in the plurality of protocols.

9. Apparatus according to claim 5, wherein the network control center is adapted to incorporate into the forward SMS message a forward identifier that enables the circuitry to recognize the forward SMS message as an authentication request, and wherein the circuitry is adapted to incorporate into the return SMS message a reverse identifier that enables the network control center to recognize the return SMS message as an authentication answer.

10. A method for enabling a mobile telephone to operate in a communications network adapted to transmit and receive data burst messages, comprising:
generating a random authentication number and an expected response to the random authentication number;
transmitting a forward data burst message incorporating the random authentication number to the mobile telephone;
generating at the mobile telephone, responsive to the random authentication number, an authentication response;
receiving from the mobile telephone a return data burst message incorporating the authentication response;
performing a comparison between the authentication response in the return data burst message and the expected response; and
authenticating the mobile telephone to operate in the communications network responsive to the comparison.

11. Apparatus for enabling a mobile telephone to operate in a communications network adapted to transmit and receive data burst messages, comprising:
a network control center which is adapted to:
generate a random authentication number and an expected response to the random authentication number,
incorporate the random authentication number in a forward data burst message, and
transmit the forward data burst message to the mobile telephone; and
circuitry, comprised in the mobile telephone, which is adapted to:
generate, responsive to the random authentication number, an authentication response,
incorporate the authentication response in a return data burst message, and
transmit the return data burst message to the network control center,
the network control center being further adapted to make a comparison between the authentication response and the expected response, and to authenticate the mobile telephone for operation in the communications network responsive to the comparison.

12. Apparatus for enabling a mobile telephone to operate in a communications network, comprising:
network controlling means which are adapted to:
generate a random authentication number and an expected response to the random authentication number,
incorporate the random authentication number in a forward short message service (SMS) message, and
transmit the forward SMS message to the mobile telephone; and
circuitry means, comprised in the mobile telephone, which are adapted to:
generate, responsive to the random authentication number, an authentication response,
incorporate the authentication response in a return SMS message, and
transmit the return SMS message to the network controlling means,
the network controlling means being further adapted to make a comparison between the authentication response and the expected response, and to authenticate the mobile telephone for operation in the communications network responsive to the comparison.

13. Apparatus according to claim 12, wherein the circuitry means are adapted to operate the mobile telephone in a plurality of different communication protocols.

14. Apparatus according to claim 13, wherein the random authentication number comprises a random-authentication-number-size, and the expected response and the authentication response each comprise an expected-response-size, and wherein the random-authentication-number-size and the expected-response-size have values responsive to respective protocols comprised in the plurality of protocols.

15. Apparatus according to claim 12, wherein the network controlling means are adapted to incorporate into the forward SMS message a forward identifier that enables the circuitry means to recognize the forward SMS message as an authentication request, and wherein the circuitry means are adapted to incorporate into the return SMS message a reverse identifier that enables the network controlling means to recognize the return SMS message as an authentication answer.
